(19) United States
(12) Patent Application Publication
(10) Pub. No.: US 2007/0009394 A1
(43) Pub. Date: Jan. 11, 2007

(54) Device for loading a multi well plate

(76) Inventor: Robert J. Bean, Germantown, TN (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/154,860

(22) Filed: Jun. 16, 2005

(51) Int. Cl. B01L 9/00

(52) U.S. Cl. 422/104

(57) ABSTRACT

A device for loading samples into a multi well plate is provided. The device has a tray configured to support the multi well plate and a cover contiguous to the tray, wherein the cover has at least one opening configured to expose at least one row of wells of the multi well plate. A method for loading samples into a multi well plate is also disclosed.

### RELATED APPLICATIONS

NONE

### STATEMENT REGARDING FEDERALLY SPONSORED RESEARCH OR DEVELOPMENT

NOT APPLICABLE

### REFERENCE A “MICROFICHE APPENDIX”

NOT APPLICABLE

### FIELD OF INVENTION

This invention relates generally to a device for loading multi well plates typically used in the chemical and biological fields. Specifically, the present invention limits the problems associated with loading the multi well plate, such as cross-contamination of samples.

### BACKGROUND OF THE INVENTION

Multi well plates are commonly employed in laboratories in performing chemical or biological tests. Multi well plates are commonly employed in research and clinical procedures to screen and evaluate multiple samples. A multi well plate is typically made of plastic and contains an array of wells organized in a grid like manner using horizontal and orthogonal rows. A multi well plate usually contains 24, 96, 384, or 1,536 individual wells which are used to contain compounds or chemicals.

Unfortunately, because of the small size of the individual wells and because of the close proximity of the wells on the multi well plate, loading samples into the wells of a multi well plate can be difficult. Problems with loading a multi well plate include cross contamination in addition to disorganization of the samples.

### BRIEF SUMMARY OF THE INVENITION

The present invention provides a device that limits the problems associated with loading the multi well plate, such as cross-contamination of samples. This invention provides a device for loading samples into a multi well plate that limits the number of individual wells exposed to the user. The multi well plate used in conjunction with the device has a plurality of wells which are configured to receive biological samples. The plurality of wells are oriented in an x-y grid using horizontal and orthogonal rows. The device is preferably used to load a multi well plate with 96 wells. The device comprises a tray configured to support the multi well plate and a cover contiguous to the tray. The cover is configured to overlap at least eighty-five percent of the multi well plate when the plate is inserted into the device. The cover has at least one opening configured to expose at least one row of wells of the multi well plate. The device further comprises at least one hinge coupling the cover to the tray.

In the preferred embodiment, the tray is made of a base panel having two side panels and a rear panel, said panels extending upward therefrom and a front member contiguous to the base panel.

In another embodiment, the tray is made of a base panel having a rear panel extending upward therefrom and a front member contiguous to the base panel.

In the preferred embodiment, the device is made of a clear or semi clear plastic which allows the user to see the orientation of current samples in the multi well plate. The plastic material allows the device to be economically manufactured and easily sterilized and cleaned.

In the preferred embodiment, the tray and the cover of the device form a central well configured to support the multi-well plate. The central well allows the multi-well plate to move in a first direction to a first end of said device and a second direction to a second end of said device.

In the preferred embodiment, the length to width ratio of the cover is 2.7 to 1. The length to width ratio of the opening is about 8.5 to 1.

Additionally, the present invention provides a method for loading samples into a multi well plate utilizing a device for loading samples into the multi well plate, wherein the device comprises a tray configured to support the multi well plate and a cover contiguous to the tray, wherein the cover has at least one opening configured to expose at least one row of wells of the multi well plate, wherein the multi well plate has a plurality of wells configured to receive biological samples, wherein the plurality of wells are oriented in an x-y grid using horizontal and orthogonal rows. The method comprises (a) inserting the multi well plate into the tray of the device; (b) aligning at least one row of wells of the multi well plate with the opening in the cover; and (c) loading the samples into the row of individual wells.

### BRIEF DESCRIPTION OF THE DRAWINGS

FIG. 1 is a front perspective view of the device for loading samples into a multi well plate.

FIG. 2 is a front perspective view of the device for loading samples into a multi well plate depicting two hinges coupling the cover to the tray.

FIG. 3 is a side perspective view of the device for loading samples into a multi well plate including the multi well plate, depicting the cover opened.

FIG. 4 is a front perspective view of the device for loading samples into a multi well plate depicting the opening of the device exposing one row of wells of the multi well plate.

FIG. 5 is a front perspective view of the device for loading samples into a multi well plate depicting two hinges coupling the cover to the tray and depicting the opening of the device exposing one row of wells of the multi well plate.

FIG. 6 is a side perspective view of the device for loading samples into a multi well plate depicting two hinges coupling the cover to the tray and depicting the cover opened.

FIG. 7 is a front perspective view of the device for loading samples into a multi well plate including the multi well plate, wherein the tray of the device does not have two side panels.

### DETAILED DESCRIPTION OF THE INVENTION

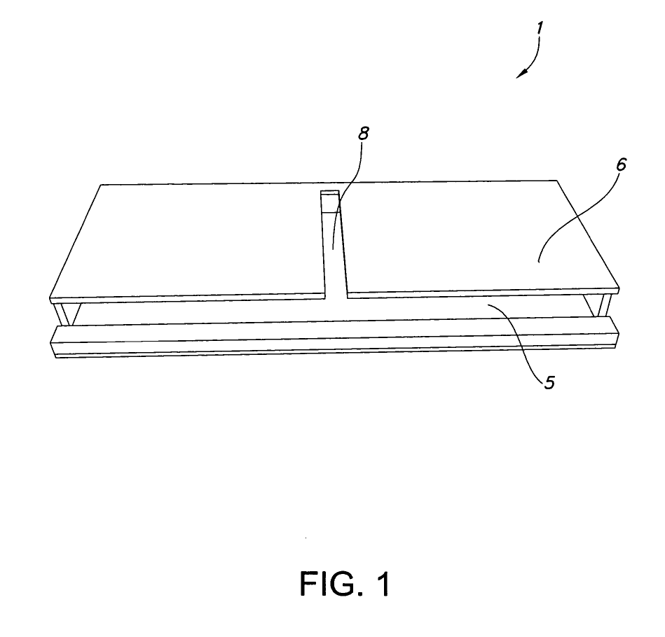

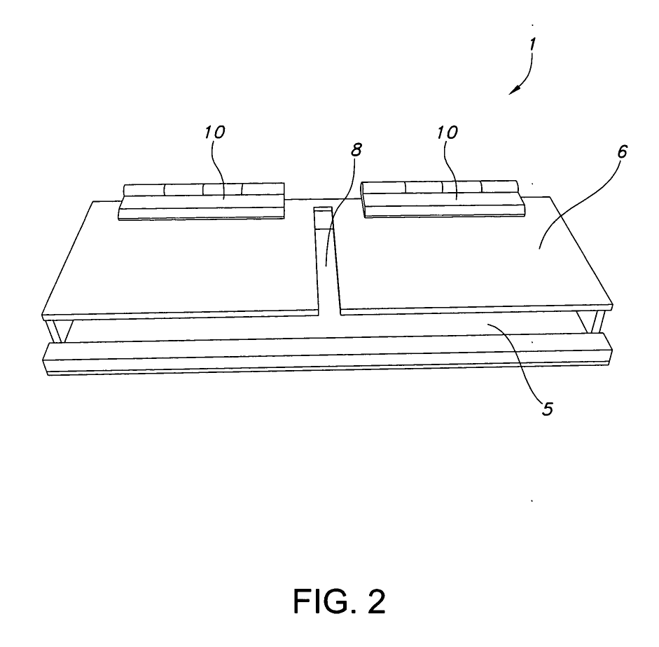

Referring now to FIGS. 1-2, the device 1 for loading samples into a multi well plate is made of a tray 5 and cover 6. The tray 5 is configured to support a multi well plate (not show in FIGS. 1-2). The length to width ratio of said tray is substantially about 2.2 to 1. Tray 5 is preferably made of clear or semi-clear plastic but any other material, such as metal, may be used as desired by one of skill in the art.

Referring again to FIGS. 1 and 2, the cover 6 of the device 1 is contiguous to tray 5. In this patent, contiguous means sharing a border or coupled to. The cover 6 is configured to overlap at least eight-five percent of the wells of the multi well plate (not shown) when inserted into tray 5. Cover 6 exposes one row of wells of the multi-well plate. The length to width ratio of the cover 6 is substantially about 2.7 to 1. Cover 6 is preferably made of clear or semi-clear plastic which allows the user to see the orientation of current samples in the multi well plate but any other material may be used as desired by one of skill in the art. Cover 6 has at least one opening 8 configured to expose at least one row of the wells of said multi well plate (not shown). The length of opening 8 is substantially about six and seven-tenths centimeters. The width of opening 8 is substantially about eight millimeters. The length to width ratio of the opening 8 is about 9.5 to 1.

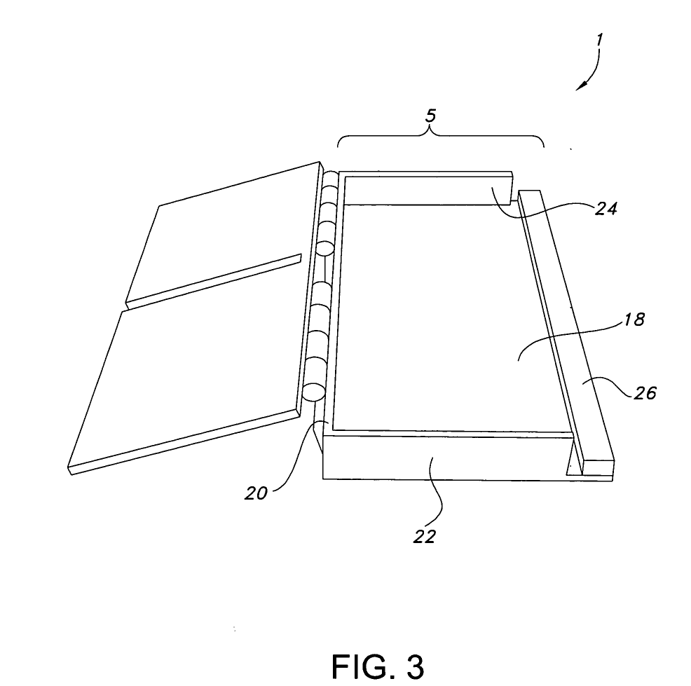

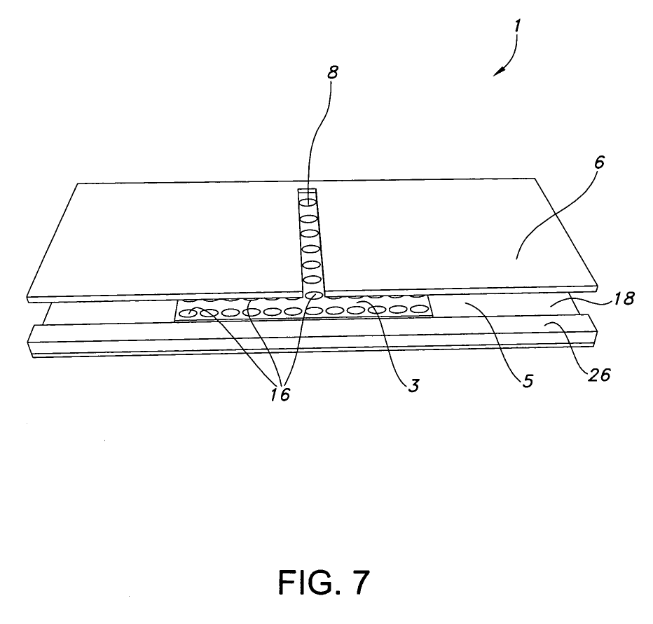

Referring to FIG. 3, in the preferred embodiment, tray 5 has a base panel 18 having two side panels 22 and 24 and a rear panel 20, the panels extending upward therefrom base panel 18, and a front member 26 contiguous to the base panel 18. The rear panel 20, two side panels 22 and 24, and front member 26 are preferably contiguous to base panel 18 in order to support the multi well plate 3 (not shown) when inserted into tray 5. Side panels 22 and 24 may be omitted from tray 5 as desired by one skilled in the art, as seen in FIG. 7.

In one embodiment, the cover 6 of device 1 does not open, as seen in FIG. 1. The height of front member 26 allows the multi well plate 3 (not shown) to be inserted into and removed from tray 5.

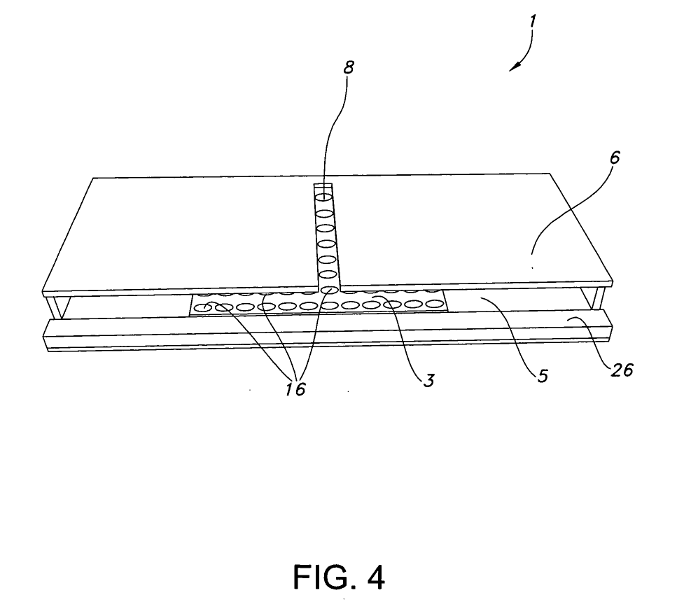

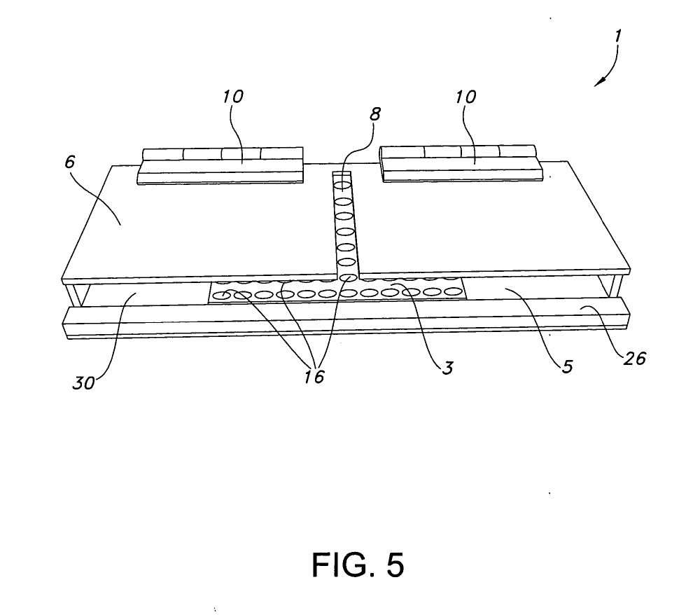

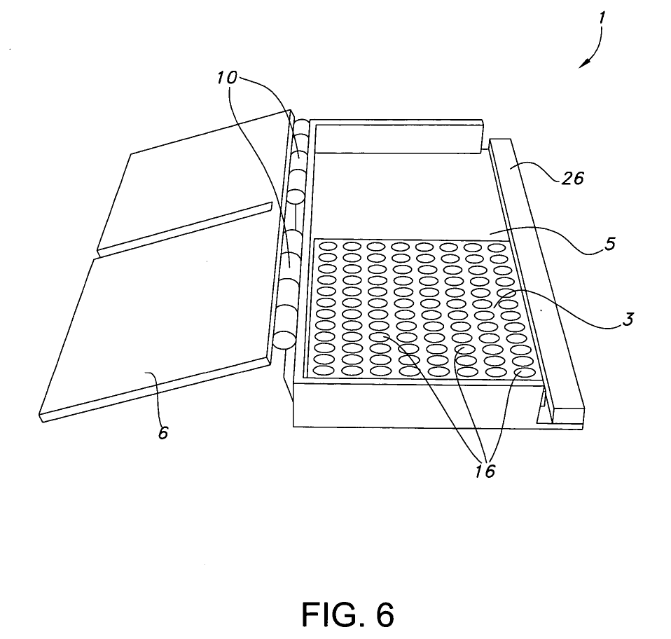

Referring now to FIGS. 5 and 6, in the preferred embodiment, cover 6 is coupled to tray 5 by two hinges 10. Other means of coupling, such as a piano hinge, may be used as desired by one of skill in the art. In another embodiment, cover 6 and tray 5 of device 1 may be manufactured as one piece as shown in FIGS. 1 and 4. As such, cover 6 is contiguous to tray 5, and cover 6 does not open. The height of front member 26 allows the multi well plate 3 to be inserted into and removed from device 1.

Referring now to FIG. 4-7, device 1 for loading samples into a multi well plate is configured to support a multi well plate 3. Multi well plate 3 has a plurality of individual wells 16 configured to receive biological or other samples. The plurality of individual wells 16 are oriented in an x-y grid using horizontal and orthogonal rows. The multi well plate 3 is inserted into tray 5 of the device 1. A user of device 1 may insert multi well plate 3 into tray 5 by sliding multi well plate 3 across front member 26 into tray 5, by sliding multi-well plate 3 in from the side of tray 5, or by opening cover 6 of tray 5 and placing the multi well plate 3 into tray 5. Method of insertion will depend on whether cover 6 is manufactured to open or to stay fixedly closed and on whether side panels 22 and 24 are omitted, as seen in FIG. 7. One row of wells of the multi well plate 3 is aligned with the opening 8 in said cover 6, as shown in FIG. 4 and FIG. 5. When aligned, the samples are then loaded in the row of individual wells exposed by opening 8.

Referring to FIG. 5, tray 5 and cover 6 of device 1 form central well 30 configured to support the multi-well plate 3. The multi-well plate 3 can move from the opposing ends of device 1 in a first direction to a first end and in a second direction to a second end.

Although the forgoing invention has been described in some detail by way of illustration and example for purposes of clarity of understanding, it will be obvious that certain changes and modifications can be made which are within the full scope of the invention.

We claim:

1. A device for loading samples into a multi well plate, said multi well plate having a plurality of wells configured to receive biological samples, said plurality of wells being oriented in an x-y grid using horizontal and orthogonal rows, said device comprising:
(a) a tray configured to support said multi well plate; and
(b) a cover contiguous to said tray, wherein said cover has at least one opening configured to expose at least one row of wells of said multi well plate.

2. The device of claim 1 further comprising at least one hinge coupling the cover to the tray.

3. The device of claim 1 further comprising two hinges coupling the cover to the tray.

4. The device of claim 1 wherein said tray comprises:
(a) a base panel having two side panels and a rear panel, said panels extending upward therefrom; and
(b) a front member contiguous to said base panel.

5. The device of claim 1 wherein said tray comprises:
(a) a base panel having a rear panel extending upward therefrom; and
(b) a front member contiguous to said base panel.

6. The device of claim 1 wherein said device is made of plastic.

7. The device is claim 1 wherein said tray and said cover form a central well configured to support the multi-well plate, wherein said central well allows the multi-well plate to move in a first direction to a first end of said device and in a second direction to a second end of said device.

8. The device of claim 1 wherein said cover is configured to overlap at least eighty-five percent of the wells of said multi well plate.

9. The device of claim 1 wherein the length to width ratio of said cover is about 2.7 to 1.

10. The device of claim 1 wherein the length to width ratio of said opening is 8.5 to 1.

11. A method for loading samples into a multi well plate utilizing a device for loading samples into the multi well plate, wherein said device comprises a tray configured to support said multi well plate and a cover contiguous to said tray, wherein said cover has at least one opening configured to expose at least one row of wells of said multi well plate, wherein said multi well plate has a plurality of wells configured to receive biological samples, wherein said plurality of wells are oriented in an x-y grid using horizontal and orthogonal rows, said method comprising:
(a) inserting the multi well plate into said tray of the device;
(b) aligning at least one row of wells of said multi well plate with the opening in said cover; and
(c) loading the samples into said row of wells.
